(19) United States
(12) Patent Application Publication
(10) Pub. No.: US 2025/0196680 A1
(43) Pub. Date: Jun. 19, 2025

(54) INTEGRATED CHARGER AND CHARGING METHOD FOR ELECTRIC VEHICLES

(71) Applicant: Garrett Transportation I Inc., Torrance, CA (US)

(72) Inventors: Ali Najmabadi, Redondo Beach, CA (US); Abhijit Sahu, Torrance, CA (US); Najib Rouhana, Les Forges (FR)

(73) Assignee: Garrett Transportation I Inc., Torrance, CA (US)

(21) Appl. No.: 18/538,317

(22) Filed: Dec. 13, 2023

(51) Int. Cl. B60L 53/24; B60K 6/24; B60K 6/26; B60K 6/48; B60L 1/00; B60L 50/75; B60L 53/16; H01M 8/04089; H01M 10/42; H01M 10/44; H01M 16/00; H02P 27/06

(52) U.S. Cl. CPC B60L 53/24; B60K 6/24; B60K 6/26; B60K 6/48; B60L 1/003; B60L 50/75; B60L 53/16; H01M 8/04089; H01M 10/425; H01M 10/44; H01M 16/006; H02P 27/06; B60L 2210/10; B60L 2210/30; B60Y 2200/91; B60Y 2200/92; B60Y 2400/112; B60Y 2400/202; B60Y 2400/44; B60Y 2400/87; H01M 2220/20; H01M 2250/20

(57) ABSTRACT

An integrated charger for electric vehicles employs a multi-phase auxiliary motor on the vehicle to charge the traction battery. The stator of the electric motor includes first windings and second windings that are phase-staggered. One of the sets of windings is put into connection with an external AC power source via a switching unit, which also isolates the vehicle's traction battery from the external source. The AC current excites an alternating current in the second windings, which is rectified and used for charging the traction battery.

### BACKGROUND OF THE INVENTION

This application relates generally to electric vehicles, and relates more particularly to arrangements for charging the traction battery of electric vehicles.

The automotive and truck industry continues to move toward vehicle architectures that employ electric drive technology, as a replacement or supplement to the use of fossil fuel-powered drive technology. Numerous electric vehicle architectures have been proposed and put into production, but nearly all can be roughly divided into two categories: all-electric or so-called battery electric vehicles (BEV) whose sole power source is one or more high-capacity, high-voltage traction batteries aboard the vehicle for powering one or more electric traction motors for driving the vehicle wheels; and hybrid electric vehicles (HEV) that, like BEVs, include one or more onboard high-voltage traction batteries to power the traction motor(s), but also include a supplemental power source that can augment the battery power and, when necessary, can become the main power source, such as when the traction battery lacks sufficient charge to do the job.

In production HEVs thus far, the supplemental power source is an internal combustion engine (ICE). Two alternative drive types exist for HEVs. In parallel HEVs, both the ICE and the traction motor are mechanically coupled in parallel to the vehicle wheels through a transmission so that either one alone, or both together, can drive the wheels. In series HEVs, only the traction motor is mechanically coupled to the vehicle wheels, while the ICE is employed to drive a generator that supplies electrical power to the traction motor. Regardless of specific drive type, however, in general the traction motor of HEVs is always in driving engagement with the vehicle wheels because there is no clutch or the like to disengage the traction motor from the wheels.

Another type of HEV that has been proposed and prototyped is the fuel cell electric vehicle (FCEV) in which the supplemental power source is a hydrogen-powered fuel cell stack instead of an ICE. In FCEVs, the fuel cell produces electrical power directly (replacing the ICE/generator of the traditional HEV) and supplies it to the traction motor for driving the vehicle wheels. In theory, therefore, the FCEV does not require a traction battery because the fuel cell provides electrical power. In practice, however, FCEVs currently in development include some type of battery so that sole reliance is not placed on the hydrogen-powered fuel cell. It may be advantageous to include a large enough battery to power the vehicle for some distance in case the onboard hydrogen tank in the vehicle runs out, which is a likely scenario at least in the early years of FCEV deployment because of the paucity of hydrogen fueling stations (currently there are about 50 such stations in the United States, nearly all of them in California).

A similar incentive exists for HEVs to be able to run solely on battery power, not because gasoline is hard to find, but because many drivers have relatively short commutes to work or school. In such a scenario, it would be desirable to be able to commute back and forth without having to consume much if any gasoline. This would obviously require charging the battery frequently, and hence reliance on external fast-charging stations would be inconvenient. Analogously, at least one major automaker has plans to begin limited production of a plug-in fuel cell electric vehicle in the near future.

In view of these considerations, plug-in hybrid vehicles have been developed. A PHEV (or PFCEV) can charge the battery using either an onboard charger or an off-board charger. Onboard chargers receive AC current (120V or 240V) from an external source and employ a number of electronics packages to convert the supplied AC current to DC current at the correct power factor (PF), amperage and voltage for the battery. Off-board chargers output DC current at the correct PF, amperage and voltage. The fastest external charging stations (Level 3) are DC chargers. For greatest versatility, PHEVs generally are designed to be able to use all of the various charger facilities, and therefore they require an onboard charger for use when the vehicle is plugged into an ordinary 120 VAC or 240 VAC outlet.

In addition to these types of plug-in hybrid and fuel cell electric vehicles, of course battery electric vehicles also require plugging in to an external power source to charge the traction battery, either from fast-charging DC stations or conventional AC power outlets. The common denominator in many of these vehicle architectures is the presence of a traction battery to power a traction motor that is always connected to the vehicle wheels.

Safety and performance considerations dictate that onboard chargers include some type of isolation stage for providing galvanic isolation between the traction battery and the external power source. The onboard charger and isolation stage represent additional cost and weight for the vehicle. For this reason, proposals have been made for utilizing already existing equipment on a hybrid vehicle to provide the required DC current and galvanic isolation to charge the traction battery. One such proposal is to have the traction motor do double duty, operable in either a traction mode to drive the vehicle wheels, or a charge mode to charge the battery. In the charge mode, two sets of windings of the traction motor are employed to provide the required galvanic isolation. The current received through the charge port is conditioned (e.g., corrected for power factor), then supplied as alternating current to a first winding set, inducing an alternating current in a second winding set, which is then rectified through a second inverter and fed to the traction battery to charge it. In the charge mode, the rotating magnetic field produced by the first winding set acts on the rotor of the traction motor to exert torque on the rotor. However, as noted above, because the traction motor is directly coupled to the vehicle wheels, the rotor cannot be allowed to rotate. Accordingly, either a clutch is required for disengaging the traction motor from the wheels, or a rotor lock is needed for locking the rotor in place. There are cost- and performance-related drawbacks to each of these measures.

### SUMMARY OF THE DISCLOSURE

The present disclosure describes methods and apparatuses for charging the traction battery in electric vehicles, capable of providing galvanic isolation between the charge port and the traction battery using existing equipment already on the vehicle, and without requiring either a clutch or a rotor lock. Distinct advantages are thereby facilitated.

The invention can be practiced with many EV architectures. In the case of PHEVs and PFCEVs, they typically include means for improving the efficiency of the ICE (in the case of PHEVs) or the fuel cell stack (in the case of PFCEVs). Thus, the ICE in a PHEV can be coupled with a so-called eTurbo, comprising a turbocharger (compressor plus exhaust gas-driven turbine) connected with an electric motor of the permanent magnet induction type. Alternatively, a so-called eCompressor can be used. The motor of the eTurbo or eCompressor can be activated selectively to drive (or in the case of the eTurbo, to sometimes assist the turbine in driving) the compressor to boost the intake pressure of the ICE, increasing the overall efficiency of the ICE. Similarly, the fuel cell stack of a PFCEV can be coupled with an eCompressor for providing higher-pressure air to the fuel cell stack, increasing its efficiency. In the case of all-electric vehicles, traction battery cooling is a major issue because of the significant amount of heat generated by the traction battery. Accordingly, circulation of a coolant for battery cooling is required, and the circulation of the coolant is accomplished by an electric motor-driven compressor or pump.

In the present application, the term “auxiliary motor” is employed to refer to the electric motor of an eCompressor or eTurbo, as well as the electric motor of the cooling pump or compressor for battery cooling. Thus, in many EV architectures, the vehicle includes at least one auxiliary motor in addition to the traction motor for driving the vehicle wheels.

In accordance with embodiments of the invention as described herein, advantage is taken of the presence of an auxiliary motor for purposes of charging the battery. In one embodiment, a vehicle comprises:
an auxiliary motor comprising a stator and a rotor, the auxiliary motor being operable to receive alternating current for exciting windings of the stator so as to cause rotation of the rotor by electromagnetic coupling, the windings including first windings and second windings that are galvanically isolated from each other;
a traction battery;
a charge port configured for receiving an alternating current from an external power source;
power electronics connected to the charge port;
a switching unit connected between the power electronics and the traction battery;
a first inverter connected between the first windings and the traction battery via the switching unit; and
a second inverter connected between the second windings and the traction battery;
wherein the switching unit is configurable in at least a run configuration and a charge configuration, the run configuration establishing a connection between the traction battery and the first windings such that the auxiliary motor is energized, the charge configuration establishing a connection between the power electronics and the first windings while isolating the traction battery from the charge port such that current supplied from the external power source excites the first windings to induce current in the second windings, said current being rectified by the second inverter to charge the traction battery.

An advantage of the above-described embodiment is that the rotor of the auxiliary motor can be allowed to rotate during charging of the traction battery by the external power source. Thus, while architectures that employ the traction motor as the galvanic isolation device must either lock the rotor or disengage the traction motor from the vehicle wheels during charging, embodiments of the invention have no such constraint because the auxiliary motor for the compressor is not engaged with the vehicle wheels. Allowing the rotor to spin during charging improves the coupling factor between the stator and the rotor, yielding improved efficiency of the charging system.

### BRIEF DESCRIPTION OF THE DRAWINGS

Having described the present disclosure in general terms, reference will now be made to the accompanying drawing(s), which are not necessarily drawn to scale, and wherein:

FIG. 1 is a block diagram of a plug-in hybrid electric vehicle in accordance with one embodiment of the invention;

FIG. 2 is a block diagram of a plug-in fuel cell electric vehicle in accordance with another embodiment of the invention;

FIG. 3 is a circuit diagram showing an exemplary architecture for connecting a switching unit between the power electronics and the windings of the auxiliary motor, and the first and second inverters and traction battery in accordance with an embodiment of the invention;

FIG. 4 is a diagrammatic illustration of an eCompressor or eTurbo suitable for the practice of embodiments of the invention; and

FIG. 5 is a cross-sectional view through the eCompressor or eTurbo of FIG. 4.

### DETAILED DESCRIPTION OF THE DRAWINGS

The present disclosure will now be described in fuller detail with reference to the above-described drawings, which depict some but not all embodiments of the invention(s) to which the present disclosure pertains. These inventions may be embodied in various forms, including forms not expressly described herein, and should not be construed as limited to the particular exemplary embodiments described herein. In the following description, like numbers refer to like elements throughout.

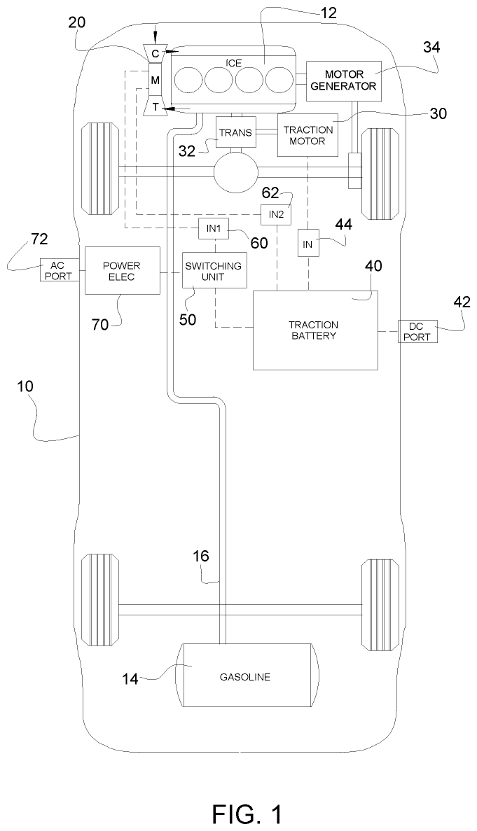

FIG. 1 illustrates an embodiment of a plug-in hybrid electric vehicle 10 in accordance with the invention. The major components of the vehicle, pertinent to the present disclosure, include an internal combustion engine (ICE) 12 that is supplied with fuel such as gasoline from a tank 14 via a fuel line 16. The ICE is coupled with an e-turbocharger (also referred to as an eTurbo) 20 comprising a compressor C, a turbine T, and an auxiliary electric motor M all mounted on the same common shaft). The compressor receives ambient air and compresses the air and supplies it to the intake of the ICE. The turbine receives exhaust gases from the ICE and expands the gases to extract rotational power from the stream of exhaust gases, which then rotatably drives the compressor. The electric motor can be energized selectively to assist the turbine in driving the compressor; in some situations, the motor can drive the compressor alone, such as before the ICE is started, which can be advantageous for certain purposes.

The PHEV 10 further includes a traction motor 30. The ICE and the traction motor are coupled to some of the vehicle wheels (in the illustrated embodiment, the front wheels) via a transmission 32. Optionally, the vehicle can include a motor/generator 34 coupled with the vehicle wheels to enable regenerative braking whereby braking of the vehicle wheels drives the motor/generator to generate electrical current that can charge the traction battery 40. The traction battery is connected to the traction motor via an inverter 44 (and associated circuitry, not shown) for supplying electrical current to power the traction motor for driving the vehicle wheels during a traction mode of vehicle operation. In a charge mode, the traction battery 40 can be charged at specially designed external charge stations via a DC charge port 42. Such charge stations supply a DC current at the correct voltage, amperage, and power factor for charging the traction battery directly.

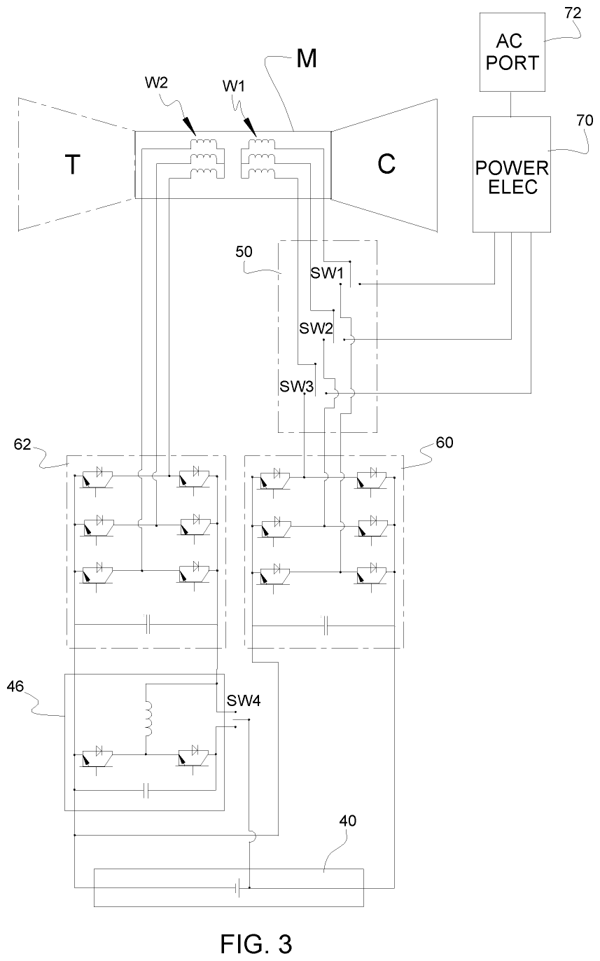

For versatility, however, PHEVs and other electric vehicle types generally are designed to allow various charging options, including charging with commonly available AC power supplies such as 110-120 VAC or 220-240 VAC outlets that are widely used in homes and places of business. To this end, the vehicle 10 includes an AC charge port 72 that connects with power electronics 70. The power electronics perform various conditioning operations on the AC current received through the AC charge port, and commonly include an EMI filter, circuitry for improving or correcting the power factor, and a rectifier for transforming the current to DC. The vehicle also includes a switching unit 50 that is connected between the traction battery 40 and the power electronics 70, and between the power electronics and a first inverter 60, which in turn is connected to the auxiliary motor M of the turbocharger. The system further comprises a second inverter 62 connected between the traction battery 40 and the auxiliary motor M of the turbocharger. The interconnections between the external AC power source, the switching unit, the traction battery, the first and second inverters, and the auxiliary motor enable a charging function that can charge the traction battery from the AC power source. The charging mode is further explained below in connection with FIG. 3.

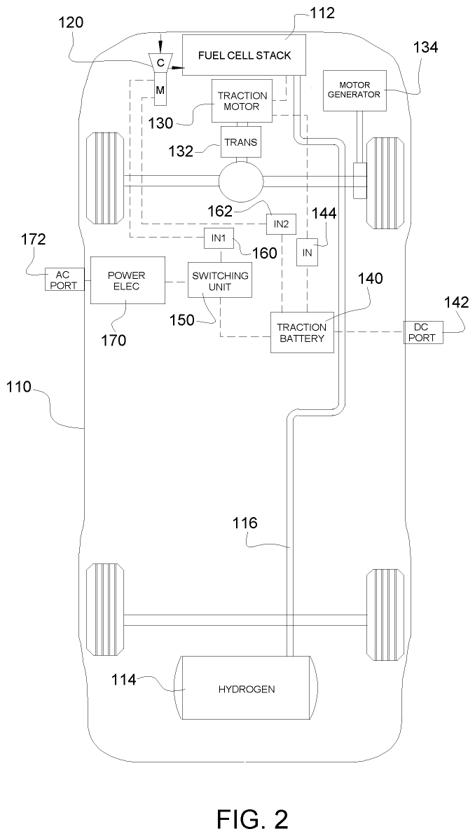

FIG. 2 is similar to FIG. 1, but illustrates a plug-in fuel cell electric vehicle 110. Analogous components of the PFCEV 110 have similar reference numerals as those in FIG. 1, but with the addition of “100” (hence, traction motor 130 is analogous to traction motor 30 of the first embodiment, etc.), although there are notable differences. Thus, the PFCEV has a fuel cell stack 112 instead of an internal combustion engine, and an eCompressor 120 instead of an eTurbo. The fuel cell stack receives hydrogen gas from a tank 114 via a fuel line 116. In terms of the above-noted components enabling the charging function, the PFCEV is substantially similar to the PHEV.

Turning to FIG. 3, the charging functionality provided by the present invention is tied to the fact that the auxiliary motor M of the eTurbo or eCompressor (or the compressor for cooling the traction battery, in the case of all-electric vehicles) is a multiphase machine having multiple windings that are galvanically isolated from one another. For example, the auxiliary motor can be a six-phase motor in which the stator includes six windings spatially distributed in either a symmetric or asymmetric arrangement, the six windings comprising two three-phase machines that are spatially staggered and hence phase-staggered relative to each other. FIG. 3 diagrammatically depicts the windings, comprising first windings W1 and second windings W2. The traction battery 40 can be selectively connected to the first windings W1 via first inverter 60 by positioning switching unit 50 in a run mode position; second windings W2 are always connected to the traction battery via second inverter 62 and hence the run mode position energizes the auxiliary motor. Alternatively, by positioning switching unit 50 in a charge mode position, the first windings W1 are placed in connection with the AC charge port 72 and power electronics 70, galvanically isolating the traction battery from the charge port, as further described below.

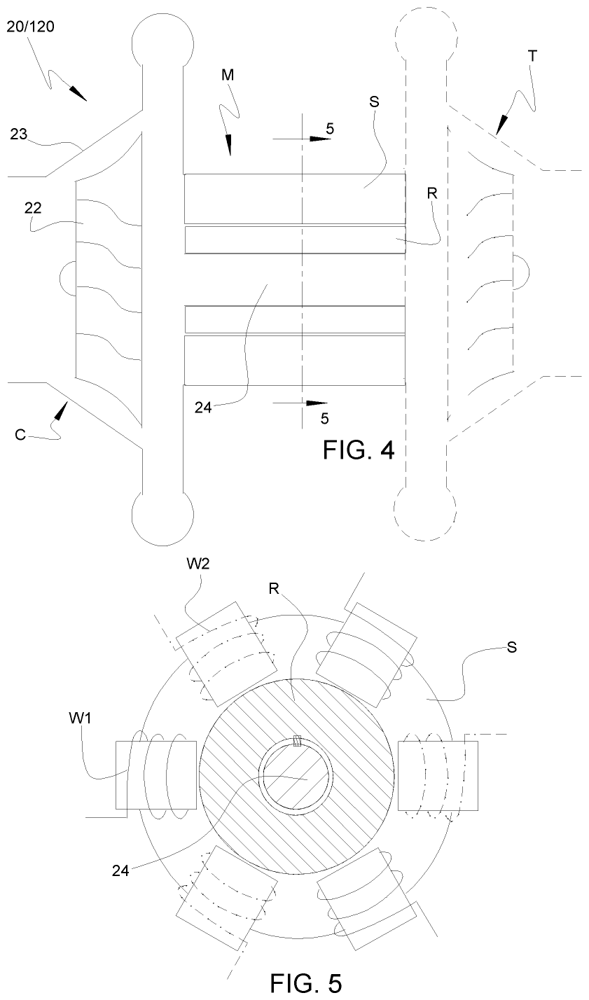

FIGS. 4 and 5 are diagrammatic illustrations of an eTurbo 20 or an eCompressor 120 that is suitable for the practice of embodiments of the invention. The compressor comprises a compressor wheel 22 withing a compressor housing 23 and mounted on a shaft 24. The shaft is coupled with the rotor R of the auxiliary motor having a stator S with multiple stator windings arranged in a distributed fashion as shown in FIG. 5. The stator as shown comprises a six-phase machine comprising two three-phase machines that are out of phase with each other; either a symmetric distribution (as shown) or an asymmetric distribution can be used. Thus, energizing the windings of the stator results in a rotating electromagnetic field that exerts a torque on the rotor via electromagnetic coupling, and the rotor thereby drives the shaft 24 to operate the compressor to pressurize air for supply to an ICE or fuel cell stack.

Returning to FIG. 3, the switching unit comprises switches SW1, SW2, and SW3 respectively connected to the power electronics 70, the first windings W1, and the first inverter 60. A DC-DC converter 46 is connected between the traction battery 40 and the second inverter 62 and includes a switch SW4 for selectively connecting or bypassing the DC-DC converter. In a run mode position of the switches, the traction battery 40 is connected to the first windings W1 via the first inverter 60, and the switch SW4 is positioned to bypass the DC-DC converter; since the traction battery is always connected to the second windings W2 via the second inverter 62, the traction battery and inverters supply alternating current to the two sets of windings to power the auxiliary motor of the eTurbo or eCompressor for producing pressurized air for delivery to the ICE or fuel cell stack. In the case of an electric vehicle having an auxiliary motor powering a cooling pump or compressor, the run position operates the auxiliary motor to supply coolant to the traction battery.

In a charge mode position of the switches SW1-SW4, the traction battery and first inverter are disconnected from the first windings W1, and the first windings are put into connection with the alternating current coming from the charge port 72 and power electronics 70, which excites the first windings and induces an alternating current in the second windings W2. The switch SW4 is positioned to connect the DC-DC converter. The second inverter 62 rectifies the induced alternating current, and the switches of the DC-DC converter can be controlled by a controller (not shown) to regulate the voltage and improve the power factor so as to supply a suitable DC current to the traction battery 40 to charge it.

Based on the foregoing description of certain embodiments of the invention, persons skilled in the art will readily recognize that the invention provides an integrated charger and charging method for electric vehicles that dispenses with the need for a dedicated onboard charger and utilizes the already-present auxiliary motor for providing galvanic isolation between the traction battery and the external power source during AC charging of the traction battery. By utilizing the auxiliary motor instead of the main traction motor, the auxiliary motor can be allowed to rotate during charging and thereby facilitate improved efficiency through enhanced electromagnetic coupling between the stator and the rotor. The invention thus provides a significant contribution to the state of the art related to charging of electric vehicles.

Persons skilled in the art, on the basis of the present disclosure, will recognize that modifications and other embodiments of the inventions described herein can be made without departing from the inventive concepts described herein. As one example, persons skilled in the art will understand that the topology for the charging system as shown in FIG. 3 is only one of numerous possible topologies that can be used to provide substantially the same functionality in the practice of the invention. The invention is not limited to any particular type of multiphase motor Specific terms used herein are employed for explanatory purposes rather than purposes of limitation. Accordingly, the inventions are not to be limited to the specific embodiments disclosed, and modifications and other embodiments are intended to be included within the scope of the appended claims.

What is claimed is:

1. A vehicle comprising:
an auxiliary motor comprising a stator and a rotor, the auxiliary motor being operable to receive alternating current for exciting windings of the stator so as to cause rotation of the rotor by electromagnetic coupling, the windings including first windings and second windings that are galvanically isolated from each other;
a traction battery;
a charge port configured for receiving an alternating current from an external power source;
power electronics connected to the charge port;
a switching unit connected between the power electronics and the traction battery;
a first inverter connected between the first windings and the traction battery via the switching unit; and
a second inverter connected between the second windings and the traction battery;
wherein the switching unit is configurable in at least a run configuration and a charge configuration, the run configuration establishing a connection between the traction battery and the first windings such that the auxiliary motor is energized, the charge configuration establishing a connection between the power electronics and the first windings while isolating the traction battery from the charge port such that current supplied from the external power source excites the first windings to induce current in the second windings, said current being rectified by the second inverter to charge the traction battery.

2. The vehicle of claim 1, further comprising an internal combustion engine, the auxiliary motor being coupled with a compressor supplying air to the internal combustion engine.

3. The vehicle of claim 2, further comprising a turbine coupled with the compressor, the turbine being arranged to receive exhaust gases from the internal combustion engine and to expand the exhaust gases to produce power to drive the compressor.

4. The vehicle of claim 1, further comprising a fuel cell stack, the auxiliary motor being coupled with a compressor supplying pressurized air to the fuel cell stack.

5. A method for charging electric vehicles that include a traction motor in driving connection with wheels of the vehicle and a traction battery for powering the traction motor, and an auxiliary motor, wherein the auxiliary motor includes first windings and second windings that are galvanically isolated from each other, the method comprising the steps of:
receiving, through a charge port of the vehicle, an alternating supply current from an external source;
filtering and power factor correcting the supply current to produce a source current;
exciting the first windings with the source current to induce a second alternating current in the second windings; and
rectifying the second alternating current to produce a direct charging current and charging the traction battery with the charging current.

6. The method of claim 5, wherein a rotor of the auxiliary motor is allowed to rotate during charging of the traction battery.

7. The method of claim 5, further comprising using a DC-DC converter to regulate the voltage of the charging current before feeding to the traction battery.
